(19) United States
(12) Patent Application Publication
(10) Pub. No.: US 2005/0283280 A1
(43) Pub. Date: Dec. 22, 2005

(54) Vehicle sensing system

(76) Inventor: Alan F. Evans JR., Rochester Hills, MI (US)

Correspondence Address: HARNESS, DICKEY & PIERCE, P.L.C., P.O. BOX 828, BLOOMFIELD HILLS, MI, 48303, US

(21) Appl. No.: 11/077,395

(22) Filed: Mar. 10, 2005

Related U.S. Application Data
(60) Provisional application No. 60/580,585, filed on Jun. 17, 2004.

(51) Int. Cl. G05D 1/00

(52) U.S. Cl. 701/1

(57) ABSTRACT

A sensing system in a vehicle for stopping a moveable object from contacting a stationary object is presented. A seal is coupled to either the moveable or to the stationary object. The seal has a first end and a second end. A signal generator is coupled to the first end of the seal.

### CROSS-REFERENCE TO RELATED APPLICATIONS

This application claims the benefit of U.S. Provisional Application No. 60/580,585, filed on Jun. 17, 2004. The disclosure of the above application is incorporated herein by reference.

### BACKGROUND AND SUMMARY OF THE INVENTION

The present invention generally relates to a sensing system, and more particularly to a sensing system that prevents an object from being pinched in a vehicle.

Anti-pinch protection sensing systems used in the roof or windows of a vehicle prevent a person from being physically harmed. An anti-pinch sensing system requires a driver to continuously activate a switch (e.g., depress a button) to close a moveable portion onto a stationary portion of the roof. While performing this act, the driver watches the moveable portion close onto the stationary portion to ensure another person does not place a finger or hand between the two portions of the roof. If this does occur, the driver must immediately stop depressing the button.

In accordance with the present invention, a sensing system is provided for an automotive vehicle. In another aspect of the present invention, a seal is coupled to either a movable or a stationary object in the vehicle. In still another aspect of the present invention, the seal has a first end and a second end. Another aspect of the present invention involves a control module that is coupled to the first and second end of the seal. In yet another aspect of the present invention, the control module generates a first and a second signal through the seal. In still yet another aspect of the present invention, the second signal is a reference signal. In a further aspect of the present invention, the control module compares the first and second signals. In another aspect of the present invention, the control module determines that a substantial difference exists between the first and second signals. In still yet another aspect of the present invention, the control module signals an actuator to stop a motion of the movable object. This sensing system is advantageous since a person may close a moveable object onto a stationary object without directing his or her full attention to the task. Additionally, this sensing system does not require a person to continuously depress a button to move a movable object onto a stationary object.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a fragmentary and perspective view of vehicle of the present invention;

FIG. 2 is a fragmentary and perspective view of a stationary portion of the roof of the present invention;

FIG. 3 is a fragmentary and perspective view of a roof in a partially closed position of the present invention;

FIG. 4 illustrates a fragmentary and perspective view of the stationary portion of a roof coupled to a seal of the present invention;

FIGS. 5A-5B are cross-sectional views of a seal of the present invention;

FIG. 6 is a fragmentary and perspective view of a vehicle of the present invention;

FIG. 7 is a block diagram of a control module coupled to a seal of the present invention;

FIG. 8 illustrates a waveform of a signal that passes through a seal without a pinch;

FIG. 9 illustrates a waveform of a signal that passes through a seal with a pinch; and

FIG. 10 is a flow diagram for sensing a foreign object pinching a seal.

### DETAILED DESCRIPTION OF THE PREFERRED EMBODIMENTS

The following description of the preferred embodiments is merely exemplary in nature and is in no way intended to limit the invention, its application, or uses. For purposes of clarity, the same reference numbers will be used in the drawings to identify similar elements. As used herein, the term “module” refers to an application specific integrated circuit (ASIC), an electronic circuit, a processor (shared, dedicated, or group) and memory that execute one or more software or firmware programs, a combinational logic circuit, or other suitable components that provide the described functionality.

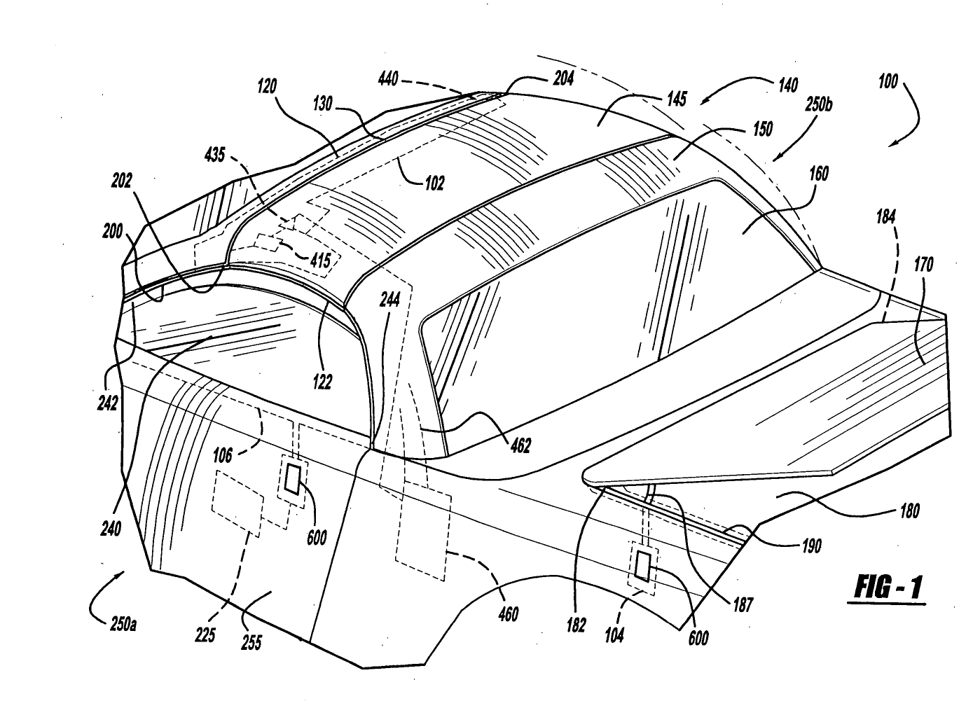

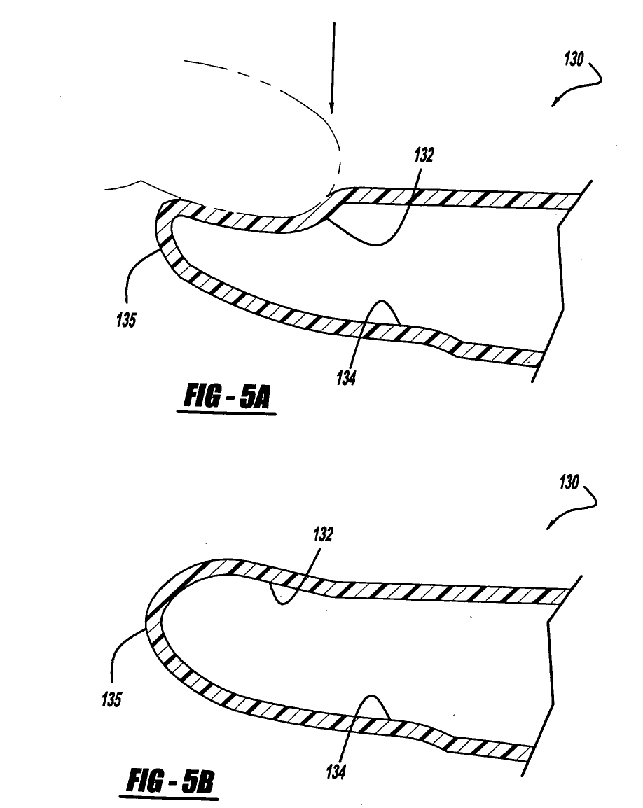

FIGS. 1-10 show the preferred embodiments for an exemplary sensing system in an automotive vehicle 100 of the present invention. First, second, and third sensing systems 102, 104, and 106 are used in vehicle 100. First sensing system 102 determines whether a foreign object pinches a seal 130 disposed between a moveable portion 140 of the roof and a stationary portion 120. In this embodiment, first sensing system 102 is connected to stationary portion 120, which may be a header or part of the roof. Skilled artisans understand that sensing system 102 may alternatively be connected to moveable portion 140. Moveable portion 140 comprises a hard top rear roof 150, a rigid rear window or backlite 160, and a hard top front roof 145. An example of the mechanism to control moveable portion 140 of the roof is found in U.S. Pat. No. 6,695,385, entitled Vehicle Convertible Roof, issued to Lange on Feb. 24, 2004. The information disclosed in this patent is incorporated herein by reference.

Sensing system 102 includes a seal 130, a signal generator 415, a receiver 440, and a comparator 435. Seal 130 has a cylindrically shaped body with a first end 202 and a second end 204. Additionally, seal 130 lacks a conductive inner surface (e.g., metallic surface, etc.), which is required by some conventional sensing systems. Seal 130 extends along a length between moveable and stationary portions of the roof 140, 120 from the driver's side 250a to the passenger's side 250b of vehicle 100.

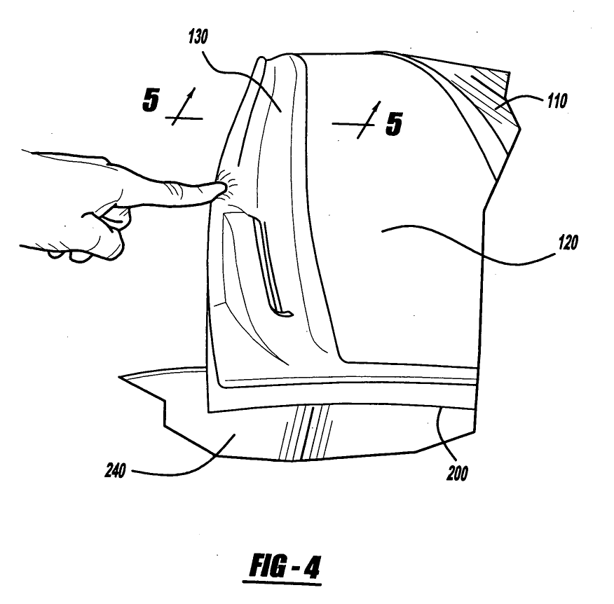

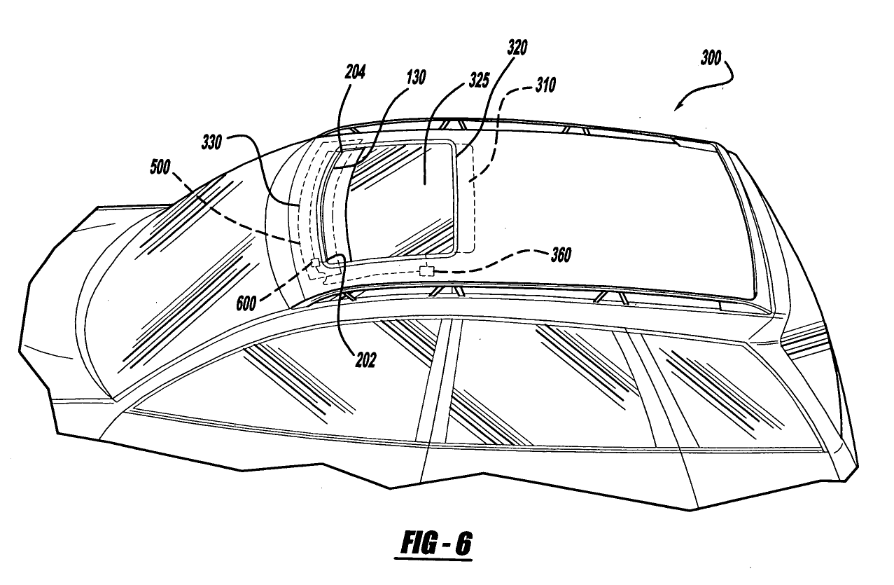

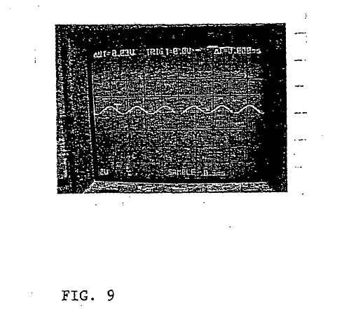

Signal generator 415 generates a first signal (e.g., ultrasound signal, etc.) that passes through first and second ends 202, 204 of seal 130 to a receiver 440. Receiver 440 may be an audible transducer, an ultrasound transducer, or other suitable device. Receiver 440 then sends the first signal to comparator 435. The first signal has a waveform similar to that shown in FIG. 8 when seal 130 is pinched or FIG. 9 when seal is not pinched. A pinched seal is shown in FIGS. 3-4 and 5A. FIG. 5A depicts a cross-sectional view of a convex or bulbous portion 135 of seal 130. An inner side 132 is not required to contact diametrically opposing inner side 134 for a pinched seal to be detected, as required by some conventional sensing systems. Comparator 435 also receives a second signal from signal generator 415. The second signal is a base or a reference signal that has a waveform shown in FIG. 9. A base or reference signal is a signal that passes through an unobstructed seal 130, as shown in FIG. 5B. An unobstructed seal 130 occurs when a foreign object such as a finger is not pressing against seal 130.

Comparator 435 then compares the amplitudes between the first and the second signals. The signal output from comparator 435 connects to actuator 460. If there is no substantial difference between the first and second signals, comparator 435 outputs a low voltage level signal to actuator 460. The low voltage level signal does not deactivate actuator 460. Therefore, actuator 460 continues to move arm 462, which in turn moves moveable portion 140 of the roof. In contrast, if a substantial difference between the first and second signals exists, comparator 435 generates a high voltage signal to actuator 460 to stop its motion. After actuator 460 stops the moveable portion 140, actuator 460 may reverse the motion of roof 140 back to its original position near the proximal end of trunk 170.

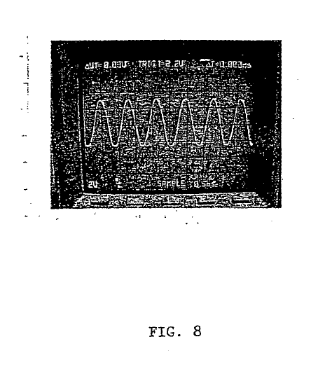

Second and third sensing systems 104 and 106 operate in a manner similar to sensing system 102. Second sensing system 104 includes control module 600 (shown in greater detail in FIG. 7) and seal 190. Seal 190 is disposed in a concave seam area that surrounds a lower stationary portion of trunk 180. The lower stationary portion of the trunk 180 is configured to receive a deck or trunk lid 170. Seal 190 has a first end 182 located behind the driver's side 250a and a second end 184 that is located at the opposing end of the vehicle 100 distal to the rear window 160. Actuator 187, coupled to trunk lid 170 and to seal 190, stops the motion of trunk lid 170 when an obstruction is detected in seal 190 by control module 600.

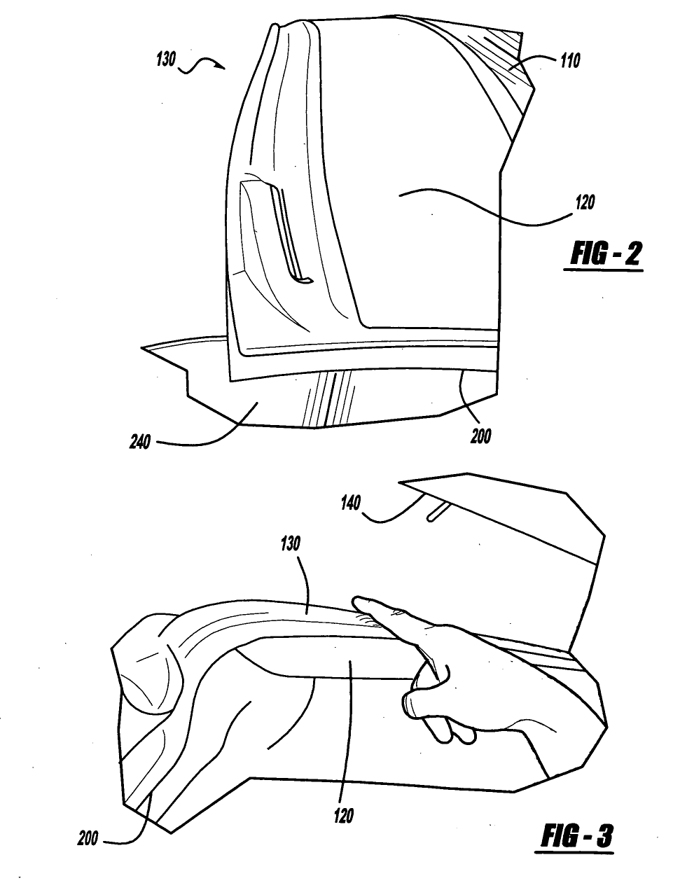

Referring to FIGS. 1 and 2, third sensing system 106 includes control module 600 coupled at a first end 242 and a second end 244 of seal 200. Seal 200 is disposed in a concave seam area of stationary portion 122 in a door 255 configured to receive window 240. When an obstruction is detected in seal 200 by control module 600, control module 600 signals actuator 225 to stop movement of window 240.

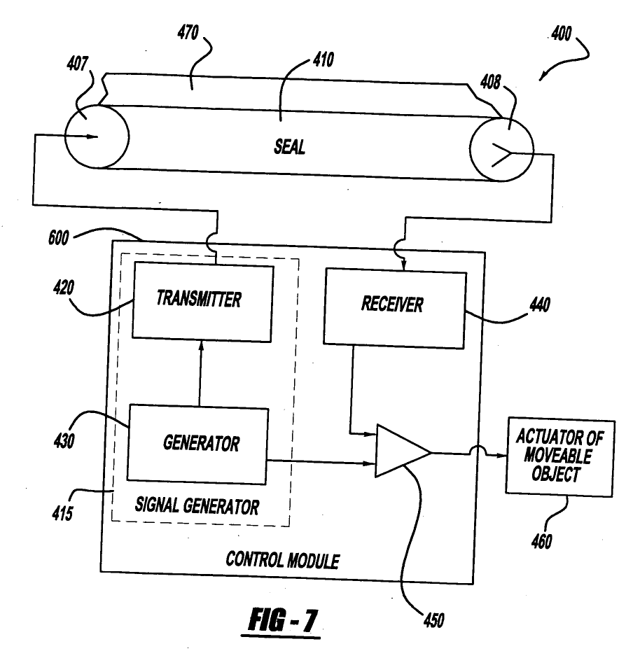

The present invention may be applied to a variety of moveable roof components that close onto stationary components. Referring to FIG. 6, vehicle 300 includes sensing system 500. Sensing system 500 is coupled to stationary portion of roof 330. Sensing system 500 includes control module 600 coupled to seal 130. Movable roof 325 slides from first position 310 to second position 320 into stationary portion of roof 330 through actuator 360. An example of the mechanism to control moveable roof 325 of the roof is found in U.S. Pat. No. 6,129,413 entitled Powered Dual Panel Sunroof, issued to Klein on Oct. 10, 2000. The information disclosed in this patent is incorporated herein by reference. If a finger presses on the seal 130 while moveable roof 325 is in motion, control module 600 signals actuator 360 to stop any motion by moveable roof 325.

FIG. 7 is a schematic diagram of sensing system 400 of the present invention. Sensing system 400 includes control module 600 coupled to object 470, which is either moveable or stationary. Control module 600 includes seal 410, signal generator 415, receiver 440, and comparator 450. Seal 410 has a first end 407 and a second end 408. Signal generator 415 is coupled to the first end 407 of seal 130. Receiver 440 is coupled to the second end 408 of seal 130. Signal generator 415 comprises generator 430 connected to transmitter 420. Generator 430, shown in ghost lines, generates a first signal through seal 130 to transmitter 420 that preferably exceeds the frequency range of human hearing. Transmitter 420 then transmits the first signal to receiver 440. Generator 430 also generates a second signal. The second signal is a base signal that is established when transmitter 420 sends a signal through an unobstructed seal 130.

Comparator 450 then compares the first signal to a second signal. When a substantial difference between the first and the second signals exists, the comparator 450 signals an actuator 460 to stop a motion of the moveable object. In one embodiment, a substantial difference in signals may be a 10% or less difference in a normalized ratio of the first to the second signals. In another embodiment, a substantial difference in signals may be a 5% or less difference in a normalized ratio of the first to the second signals. Once control module 600 has signaled actuator 460 to stop the motion of a moveable object, control module 600 may then signal actuator 460 to reverse the motion of the movable object.

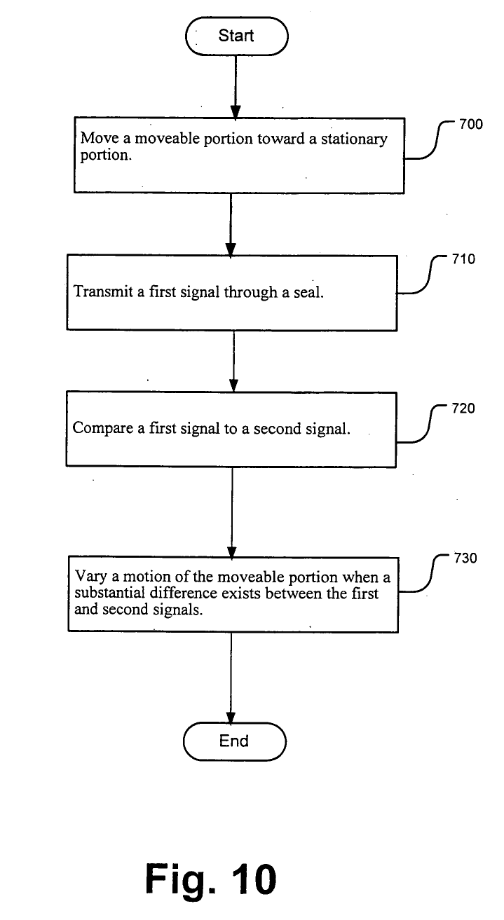

FIG. 10 is a flow diagram of a foreign object pressing against a seal. At operation 700, a moveable portion moves toward a stationary portion. At operation 710, a first signal is sent through a seal of a sensing system. At operation 720, a first signal is compared to a second signal. At operation 730, a motion of the moveable portion is varied when a substantial difference between the first and second signal exist. Skilled artisans appreciate that the sensing system is configured to continuously determine whether attenuation of a signal caused by a pinch exists. If such attenuation is undetected and the moveable portion is within a certain acceptable distance to close onto a stationary portion, the moveable portion is allowed to close.

While the preferred embodiment of the sensing system has been disclosed, various alterations can be made which fall within the scope of the present invention. Although the seal is depicted as being coupled to a stationary object, the seal may also be coupled to a moveable object. For example, the seal may be coupled to the moveable portion of the roof or the trunk lid. Skilled artisans also understand that while the seal is depicted as substantially cylindrical in shape (e.g., less than 30% difference in shape from a typical cylindrical shape), a substantially circular, U-shaped, L-shaped, straight wiper style or other may be used. In addition to the variety of shapes that the seal may include, the seal may comprise a variety of flexible materials such as polymeric, rubber, or the like. Another alternative to the present invention involves connecting a sensing system to a first moveable object and stopping the motion of the first or the second moveable object when a pinch is detected in a seal. Yet another alternative to the present invention relates to a single control module used to control a plurality of sensing systems. For instance, a single control module may be connected to the first, second, and third sensing systems in a vehicle. The single control module stops the motion of the moveable object when a foreign objects presses against a seal. Another alternative to a moveable roof relates to U.S. Pat. No. 5,864,214, issued Jan. 26, 1999, entitled “Storage Compartment Sensor System for Use with an Automotive Vehicle”, the disclosure of which is incorporated by reference in its entirety herein. Yet another alternative is a spoiler roof disclosed in U.S. Pat. No. 6,454,347, issued on Sep. 24, 2002, the disclosure of which is incorporated by reference in its entirety. The description of the invention is merely exemplary in nature and, thus, variations that do not depart from the gist of the invention are intended to be within the scope of the invention. Such variations are not to be regarded as a departure from the spirit and scope of the invention.

1. A sensing system for a vehicle comprising:
a roof having a movable portion and a stationary portion;
a seal coupled to one of the movable and stationary portions of the roof, the seal having a first end and a second end;
a control module coupled to first end and the second end of the seal, the control module comprises:
(a) a signal generator operably generates a first signal and a second signal through the seal to a receiver, the second signal being a reference signal;
(b) a comparator connected to the receiver and to the signal generator, the comparator operably compares the first signal to the second signal; and
an actuator coupled to the comparator and to the moveable portion of the roof, wherein a substantial difference between the first and the second signals causes the comparator to signal the actuator to change a motion of the moveable portion of the roof.

2. The sensing system of claim 1, wherein the seal has a substantially cylindrical shaped body, the inner portion of the cylindrical shape body lacks a conductive surface.

3. The sensing system of claim 1, wherein a pinch in the seal modifies the first signal.

4. The sensing system of claim 1, wherein a substantial difference between the first and the second signals exists when a ratio of a normalized first and the second signal is greater than 10 percent.

5. The sensing system of claim 1, wherein the receiver is one of an audible transducer and an ultrasound transducer.

6. The sensing system of claim 2, wherein the substantially cylindrical shape of the body of the seal has less than about a 30% difference from a cylindrical shaped body.

7. The sensing system of claim 1, wherein the seal includes a convex portion.

8. The sensing system of claim 1, wherein the roof is one of a convertible roof and a sun roof.

9. The sensing system of claim 1, wherein the roof is hard top panels in a convertible roof.

10. A sensing system for a moveable object and a stationary object comprising:
a flexible member coupled to one of the moveable and the stationary objects, the flexible member having a first end and a second end;
a transmitter coupled to the first end of the flexible member;
a receiver, coupled to the second end of the flexible member, configured to receive the first signal;
a generator operably sending a first signal to the transmitter through the flexible member;
a comparator operably comparing the first signal to a second signal from the generator; and
an actuator coupled to the comparator and to the moveable object, wherein a substantial difference between the first and the second signals causes the comparator to signal the actuator to change a motion of the moveable object.

11. The sensing system of claim 10, wherein the flexible member lacks a conductive surface.

12. The sensing system of claim 10, wherein a pinch in the flexible member modifies the first signal.

13. The sensing system of claim 10, wherein a substantial difference between the first and the second signals exists when a ratio of a normalized first and the second signal is greater than 10 percent.

14. The sensing system of claim 10 wherein the receiver is one of an audible transducer and an ultrasound transducer.

15. The sensing system of claim 10, wherein the substantially cylindrical shape of the body of the flexible member has less than about a 30% difference from a cylindrical shaped body.

16. The sensing system of claim 10, wherein the flexible member includes a convex portion.

17. A sensing system for a vehicle comprising:
a window configured to move from a first to a second position in a door;
a seal coupled to a stationary portion of a door configured to receive the window, the seal having a substantially cylindrically shaped body with a first end and the second end, the inner portion of the cylindrically shaped body lacks a conductive surface;
a signal generator coupled to the first end of the seal;
a receiver, coupled to the second end of the seal, operable to receive the first signal;
a comparator for comparing a first signal to a second signal from the signal generator; and
an actuator coupled to the comparator and to the window, wherein the substantial difference between the first and second signals causes the comparator to signal the actuator to stop a motion of the window.

18. The sensing system of claim 17, wherein a pinch in the seal modifies the first signal.

19. The sensing system of claim 17, wherein a substantial difference between the first and the second signals exists when a ratio of a normalized first and the second signal is greater than 10 percent.

20. The sensing system of claim 17, wherein the receiver is one of an audible transducer and an ultrasound transducer.

21. The sensing system of claim 17, wherein the substantially cylindrical shape of the body of the seal has less than about a 30% difference from a cylindrically shaped body.

22. The sensing system of claim 17, wherein the seal includes a convex portion.

23. A sensing system for a vehicle comprising:
a seal having a first end and a second end;
a stationary portion of a trunk configured to receive the seal;
a signal generator coupled to the first end of the seal;
a receiver, coupled to the second end of the seal, operable to receive a first signal from the signal generator;
a comparator for comparing the first signal to a second signal from the signal generator; and
an actuator coupled to the comparator and to the trunk lid, wherein the substantial difference between the first and second signals causes the comparator to signal the actuator to stop a motion of the trunk lid.

24. The sensing system of claim 23, wherein a pinch in the seal modifies the first signal.

25. The sensing system of claim 23, wherein a substantial difference between the first and the second signals exists when a ratio of a normalized first and the second signal is greater than 10 percent.

26. An automotive vehicle sensing system comprising:
a retractable roof;
a weatherstrip located adjacent the roof, the weatherstrip having a substantially cylindrical shaped body with a first end and a second end, an inner surface of the cylindrical shape body lacks metallic material;
a control module coupled to the first end and the second end of the weatherstrip, the control module generates a first signal and a second signal through the first and the second ends of the weatherstrip, the second signal being a reference signal, the control module being operable to compare the first signal to the second signal; and
an actuator coupled to the control module, wherein a substantial difference between the first and the second signals causes the control module to signal the actuator to stop a motion of the roof.

27. A convertible automotive vehicle roof system comprising:
an automatic actuator;
a convertible roof;
a top stack mechanism coupling the convertible roof to the automatic actuator;
a seal coupled to a stationary portion of a vehicle, the seal having a first end and a second end;
a control module coupled to first end and the second end of the seal, the control module comprises:
(a) a signal generator operably generates a first signal and a second signal through the seal to a receiver, the second signal being a reference signal; and
(b) a comparator connected to the receiver and to the signal generator, the comparator operably compares the first signal to the second signal;
an actuator coupled to the comparator and to the moveable portion of the roof, wherein a substantial difference between the first and the second signals causes the comparator to signal the actuator to change a motion of the moveable portion of the roof.

28. The convertible automotive vehicle roof system of claim 27, wherein the seal has a substantially cylindrical shaped body, an inner portion of the cylindrical shape body lacks a conductive surface.

29. The convertible automotive vehicle roof system of claim 27, wherein a pinch in the seal modifies the first signal.

30. The convertible automotive vehicle roof system of claim 27, wherein a substantial difference between the first and the second signals exists when a ratio of a normalized first and the second signal is greater than 10 percent.

31. A method for sensing a pinch in a seal in a vehicle comprising:
moving a movable portion toward a stationary portion;
sending a first signal from a transmitter through a seal to a receiver;
comparing the first signal to a second signal; and
varying a movable portion when a substantial difference between the first and second signal exists.

32. The method of claim 31, wherein the receiver is one of an audible transducer and an ultrasound transducer.

33. The method of claim 31, wherein the first signal is at a frequency that is above a hearing range for humans.

34. The sensing system of claim 31, wherein the moveable portion relates to a roof, the roof is one of a convertible roof and a sun roof.

35. The sensing system of claim 31, wherein the roof is hard top panels in a convertible roof.
